(19) United States
(12) Patent Application Publication
(10) Pub. No.: US 2013/0022811 A1
(43) Pub. Date: Jan. 24, 2013

(54) STABLE GRAPHENE FILM AND PREPARING METHOD OF THE SAME

(71) Applicants: Jong-Hyun AHN, Suwon-si (KR); Byung Hee HONG, Seoul (KR); Chao YAN, Suwon-si (KR)

(72) Inventors: Jong-Hyun AHN, Suwon-si (KR); Byung Hee HONG, Seoul (KR); Chao YAN, Suwon-si (KR)

(73) Assignee: RESEARCH & BUSINESS FOUNDATION SUNGKYUNKWAN UNIVERSITY, Suwon-si (KR)

(21) Appl. No.: 13/531,665

(22) Filed: Jun. 25, 2012

(30) Foreign Application Priority Data
Jun. 24, 2011 (KR) 10-2011-0061524

(51) Int. Cl. B32B 9/00; B05D 5/12; B32B 33/00; B82Y 40/00; B82Y 30/00

(52) U.S. Cl. 428/336; 427/122; 428/408; 977/734; 977/890

(57) ABSTRACT

The present disclosure relates to a stable graphene film, a preparing method of the stable graphene film, a graphene transparent electrode including the stable graphene film, and a touch screen including the stable graphene film.

### CROSS-REFERENCE TO RELATED APPLICATION

This application claims the benefit of Korean Patent Application No. 10-2011-0061524 filed on Jun. 24, 2011, the entire disclosures of which are incorporated herein by reference.

### FIELD OF THE INVENTION

The present disclosure relates to a stable graphene film, a preparing method of the stable graphene film, a graphene transparent electrode including the stable graphene film, and a touch screen including the stable graphene film.

### BACKGROUND OF THE INVENTION

In general, a graphite has a stacked structure of a two-dimensional graphene sheet in a plate shape, in which carbon atoms are connected to one another to form a hexagonal shape. In recent, there has been testing to inspect characteristics of the graphene sheet by taking off one layer or several layers from the graphite sheet. As a result, it was discovered that the graphene sheet has effective characteristics, which are distinguishable from those of conventional substances.

Since an electrical characteristic of the graphene sheet varies depending on crystal orientation of the graphene sheet having predetermined thickness, a user can express the electrical characteristic in a selected direction. Thus, a device can be easily designed. The characteristic of the graphene sheet can be effectively used for carbon-based electrical devices or carbon-based electromagnetic devices in the future.

In graphene, an effective mass of electrons placed near a Fermi level is very small. Accordingly, movement velocity of electrons within the graphene is almost the same as the velocity of light. Since the electrical characteristic is excellent, the graphene is drawing attention as a material for a next-generation device. Furthermore, since thickness of the graphene refers to thickness of one carbon atom, the graphene is expected to be applied to a super high-speed and ultra-thin electrical device.

However, if a device using graphene prepared under vacuum is exposed to the air, n- or p-doping occurs due to interaction with molecules of moisture, ammonia, and others included in the air, so that the electrical characteristic of the graphene may be changed. In particular, if a device is manufactured in a bottom-up manner so that the graphene is placed on the uppermost layer, there is the high possibility that the graphene contacts with the air. Further, in case of using a device using the graphene, dopant doped on the graphene is blown or deteriorated thereby degrading the conductivity.

There is a necessity to provide a protection film capable of protecting the graphene from external factors without changing the electrical characteristic of the graphene.

### BRIEF SUMMARY OF THE INVENTION

The present disclosure provides a stable graphene film provided with a protection film on top and bottom portions thereof so as to improve adhesion between graphene and a substrate and protect the graphene film from external factors, a preparing method of the stable graphene film, a graphene transparent electrode including the stable graphene film, and a touch screen including the stable graphene film.

However, problems sought to be solved by the present disclosure are not limited to the above-described problems. Other problems, which are sought to be solved by the present disclosure but are not described in this document, can be clearly understood by those skilled in the art from the descriptions below.

An aspect of the present disclosure provides a stable graphene film including a graphene film, and an insulating or conductive protection film formed on the graphene film.

In an illustrative embodiment, the protection film may contain, but not limited to, an insulating or conductive polymer, or an insulating or conductive inorganic material.

In an illustrative embodiment, an intermediate layer containing a conductive polymer or a conductive inorganic material may be further included between the protection film and the graphene film. However, the present disclosure is not limited thereto.

In another illustrative embodiment, a graphene layer may be further included between the protection film and the intermediate layer. However, the present disclosure is not limited thereto.

In another illustrative embodiment, the protection film may be a thin film having thickness of about 100 nm or less. However, the present disclosure is not limited thereto.

In another illustrative embodiment, the preparing method may further include doping the graphene film prior to forming the protection film. However, the present disclosure is not limited thereto.

In an illustrative embodiment, the protection film may have a function of preventing damage of the graphene film. However, the present disclosure is not limited thereto.

In another illustrative embodiment, the protection film may have a function of preventing degradation of the conductivity of the graphene film. However, the present disclosure is not limited thereto.

Another aspect of the present disclosure provides a graphene transparent electrode, including the above-described stable graphene film.

Another aspect of the present disclosure provides a touch screen, including the above-described graphene transparent electrode.

Another aspect of the present disclosure provides a method for preparing a stable graphene film, including forming an insulating or conductive protection film on a graphene film.

In accordance with the present disclosure, it is possible to provide a stable graphene film including an insulating or conductive protection film on top and/or bottom portions of the graphene film, and selectively further including an intermediate layer containing a conductive polymer or a conductive inorganic material between the protection film and the graphene film. The stable graphene film in accordance with the present disclosure includes the protection film and selectively includes the intermediate layer so that the adhesion of the graphene film on the substrate can be improved, and the graphene film can be protected from external factors such as air, moisture, scratches, and chemical materials. Accordingly, it is possible to prevent variation or degradation of the electrical characteristic of the graphene film. If a graphene transparent electrode including the stable graphene film prepared by the present disclosure is used as a transparent electrode included in a display such as a touch screen, the graphene transparent electrode can be protected from external scratches.

If no protection film is provided, the conductivity of the graphene transparent electrode is reduced as usage time lapses, and in the transparent electrode manufactured by using doped graphene, dopant used upon doping the graphene is blown or deteriorated so that the conductivity is reduced as the usage time lapses. However, if the graphene transparent electrode is manufactured by using the above-described stable graphene film of the present disclosure, including the graphene film and the insulation or conductive protection film formed on the graphene film, the physicochemical stability and the conductivity of the graphene transparent electrode are maintained for a long time by virtue of the insulating or conductive protection film. Further, since the dopant used upon doping the graphene is not blown or deteriorated, the physicochemical stability and the conductivity of the graphene transparent electrode can be maintained for a long time.

The stable graphene film in accordance with the present disclosure can be prepared by using graphene synthesized to have high quality and a large surface area through a chemical vapor deposition method. The stable graphene film in accordance with the present disclosure can be adopted for various applications such as a transparent electrode, a conductive thin film, a thin film transistor, a hydrogen storage medium, an optical fiber, an electronic device, a display, a sensor, and the like.

### BRIEF DESCRIPTION OF THE DRAWINGS

Non-limiting and non-exhaustive embodiments will be described in conjunction with the accompanying drawings. Understanding that these drawings depict only several embodiments in accordance with the disclosure and are, therefore, not to be intended to limit its scope, the disclosure will be described with specificity and detail through use of the accompanying drawings, in which:

FIG. 1 is a cross sectional view of a stable graphene film in accordance with an illustrative embodiment of the present disclosure;

FIGS. 2A to 2G are cross sectional views for explanation of processes of a method for preparing a stable graphene film in accordance with an illustrative embodiment of the present disclosure;

FIG. 3 is a cross sectional view of a stable graphene film in accordance with another illustrative embodiment of the present disclosure;

FIG. 4 is a cross sectional view of a stable graphene film in accordance with another illustrative embodiment of the present disclosure;

FIG. 5 is a cross sectional view of a stable graphene film in accordance with another illustrative embodiment of the present disclosure;

FIG. 6 shows whole preparation processes in accordance with Example 1 of the present disclosure;

FIGS. 7A and 7B show photographs of a graphene film after bar-coating on a 3-inch Si wafer and a PET substrate, respectively, using P4VP in accordance with Example 1 of the present disclosure;

FIG. 7C is an optical microphotograph for further identification of uniformity of a bar-coating film on a graphene surface in accordance with Example 1 of the present disclosure;

FIG. 7D is a graph showing transmittance of the graphene on the PET substrate prior to and after bar-coating with a polymer thin film in accordance with Example 1 of the present disclosure;

FIG. 8 is a graph showing variation of development of sheet resistance depending on thickness of a top portion coating layer in accordance with Example 1 of the present disclosure;

FIG. 9A is an optical microphotograph of a polymer-coated graphene film on a silicon substrate after a taping test in accordance with Example 1 of the present disclosure;

FIG. 9B shows variation of sheet resistance prior to and after a taping test for monolayer, bilayer, trilayer, and tetralayer graphene films coated with a polymer film in accordance with Example 1 of the present disclosure;

FIG. 10A is a graph showing the sheet resistance of a sample after a non-doped pristine sample is doped with AuCl₃ in accordance with Example 1 of the present disclosure;

FIG. 10B is a graph showing the sheet resistance of the AuCl₃-doped sample that varies depending on time, in accordance with Example 1 of the present disclosure;

FIG. 10C is a graph showing sheet resistance of the AuCl₃-doped and polymer-coated samples that varies depending on time, in accordance with Example 1 of the present disclosure;

FIG. 11 is a graph showing tendency of sheet resistance that varies depending on a temperature, in accordance with Example 1 of the present disclosure;

FIG. 12 is a graph obtained from measurement of a sheet resistance value of a graphene film including an intermediate layer containing a conductive polymer in accordance with Example 2 of the present disclosure;

### DETAILED DESCRIPTION OF THE INVENTION

Hereinafter, illustrative embodiments and examples of the present disclosure will be described in detail with reference to the accompanying drawings so that inventive concept may be readily implemented by those skilled in the art.

However, it is to be noted that the present disclosure is not limited to the illustrative embodiments but can be realized in various other ways. In the drawings, certain parts not directly relevant to the description are omitted to enhance the clarity of the drawings, and like reference numerals denote like parts throughout the whole document.

Throughout the whole document, the term “comprises or includes” and/or “comprising or including” used in the document means that one or more other components, steps, operations, and/or the existence or addition of elements are not excluded in addition to the described components, steps, operations and/or elements. The terms “about or approximately” or “substantially” are intended to have meanings close to numerical values or ranges specified with an allowable error and intended to prevent accurate or absolute numerical values disclosed for understanding of the present invention from being illegally or unfairly used by any unconscionable third party. Through the whole document, the term “step of” does not mean “step for”.

With respect to the terms “conductive polymer” and “conductive inorganic material” throughout the whole document, the term “conductive” is construed to include both conductivity as a conductor and conductivity as a semiconductor.

An aspect of the present disclosure provides a stable graphene film including a graphene film, and an insulating or conductive protection film formed on the graphene film.

In an illustrative embodiment, the protection film may contain, but not limited to, an insulating or conductive polymer, or an insulating or conductive inorganic material.

In an illustrative embodiment, an intermediate layer containing a conductive polymer or a conductive inorganic material may be further included between the protection film and the graphene film. However, the present disclosure is not limited thereto.

In another illustrative embodiment, a graphene layer may be further included between the protection film and the intermediate layer. However, the present disclosure is not limited thereto.

In another illustrative embodiment, the protection film may be a thin film having thickness of about 100 nm or about 50 nm or less. However, the present disclosure is not limited thereto.

In another illustrative embodiment, the insulating polymer may include, but not limited to, a curable insulating polymer. For example, the insulating polymer may include one selected from the group consisting of a thermosetting resin, an photocurable resin, and a combination thereof. However, the present disclosure is not limited thereto.

In another illustrative embodiment, the protection film may be transparent, flexible, or transparent and flexible. However, the present disclosure is not limited thereto.

In another illustrative embodiment, the insulating polymer may include one selected from the group consisting of poly methyl methacrylate (PMMA), poly 4-vinylphenol (P4VP), polystyrene-block-polyisoprene-block-polystryrene (SBS), polyvinylchloride (PVC), polypropylene (PP), acrylonitrile butadiene styrene (ABS), polycarbonate (PC)/acrylonitrile butadiene styrene (ABS), polyethylene (PE), polyethylene terephthalate (PET), polybuthylene terephthalate (PBT), polyphenylene sulfide (PPS), poly carbonate (PC), nylon, low density polyethylene (LDPE), high density polyethylene (HDPE), cross-linked polyethylene (XLPE), styrenebutadiene rubber (SBR), butadiene rubber (BR), ethylene propylene rubber (EPR), polyurethane (PU), tetraorthosilicate (TEOS), and a combination thereof. However, the present disclosure is not limited thereto.

In another illustrative embodiment, the insulating inorganic material may include one selected from the group consisting of SiO₂, a-Si (amorphous silicon), SiC, Si₃N₄, LiF, BaF₂, Ta₂O₅, Al₂O₃, MgO, ZrO₂, HfO₂, BaTiO₃, BaZrO₃, Y₂O₃, ZrSiO₄, and a combination thereof. However, the present disclosure is not limited thereto.

In an illustrative embodiment, the conductive polymer may include one selected from the group consisting of polyaniline, polythiophene, polyethylenedioxythiopene (PEDOT), polyimide, polystyrenesulfonate (PSS), polypyrrole, polyacetylene, poly(p-phenylene), poly(p-phenylene sulfide), poly(p-phenylene vinylene), polythiophene poly(thienylene vinylene), and a combination thereof. However, the present disclosure is not limited thereto.

In another illustrative embodiment, the conductive inorganic material may include one selected from the group consisting of indium tin oxide (ITO), indium zinc oxide (IZO), antimony-doped tin oxide (ATO), Al-doped zinc oxide (AZO), gallium-doped zinc oxide (GZO), indium-gallium-zinc oxide (IGZO), fluorine-doped tin oxide (PTO), ZnO, TiO₂, SnO₂, WO₃, and a combination thereof. However, the present disclosure is not limited thereto.

In another illustrative embodiment, the graphene film may be doped. However, the present disclosure is not limited thereto.

In an illustrative embodiment, the graphene film may be doped by using organic-based and/or inorganic-based dopant. However, the present disclosure is not limited thereto. For example, the organic-based dopant may include one selected from the group consisting of NO₂BF₄, NOBF₄, NO₂SbF₆, HCl, H₂PO₄, H₃CCOOH, H₂SO₄, HNO₃, dichlorodicyanoanquinon, oxon, dimyristoylphosphatidylinositol, trifluoromethane sulfonimide, and a combination thereof. However, the present disclosure is not limited thereto.

In another illustrative embodiment, the inorganic-based dopant may include one selected from the group consisting of AuCl₃, HAuCl₄, AgOTfs (silver trifluoromethanesulfonate), AgNO₃, aluminum trifluoromethane sulfonate, and a combination thereof. However, the present disclosure is not limited thereto.

In another illustrative embodiment, the graphene film may be formed on a substrate. However, the present disclosure is not limited thereto.

In another illustrative embodiment, the substrate may be an insulating substrate. However, the present disclosure is not limited thereto.

In another illustrative embodiment, the substrate may be a transparent substrate, a flexible substrate, or a transparent and flexible substrate. However, the present disclosure is not limited thereto.

In another illustrative embodiment, an adhesive layer containing an insulating or conductive polymer may be further included between the substrate and the graphene film. However, the present disclosure is not limited thereto. The insulating or conductive polymer is the same as the insulating or conductive polymer contained in the protection film.

In another illustrative embodiment, the graphene film may be formed on a metal catalyst thin film through a chemical vapor deposition method. However, the present disclosure is not limited thereto.

For example, the metal catalyst thin film may include one selected from the group consisting of Ni, Co, Fe, Pt, Au, Al, Cr, Cu, Mg, Mn, Mo, Rh, Si, Ta, Ti, W, U, V, Zr, Ge, Ru, Ir, brass, bronze, nickel, stainless steel, and a combination thereof. However, the present disclosure is not limited thereto.

In an illustrative embodiment, the protection film may have a function of preventing damage of the graphene film. However, the present disclosure is not limited thereto.

In another illustrative embodiment, the protection film may have a function of preventing degradation of the conductivity of the graphene film. However, the present disclosure is not limited thereto.

Another aspect of the present disclosure provides a graphene transparent electrode, including the above-described stable graphene film.

Another aspect of the present disclosure provides a touch screen, including the above-described graphene transparent electrode.

Another aspect of the present disclosure provides a method for preparing a stable graphene film, including forming an insulating or conductive protection film on a graphene film.

In an illustrative embodiment, the preparing method may include: forming the graphene film on a substrate; and forming the protection film containing an insulating or conductive polymer or an insulating or conductive inorganic material on a top portion of the graphene film. However, the present disclosure is not limited thereto.

In an illustrative embodiment, the preparing method may further include forming an intermediate layer containing a conductive polymer or a conductive inorganic material between the protection film and the graphene film. However, the present disclosure is not limited thereto.

In another illustrative embodiment, the preparing method may further include forming the graphene film between the protection film and the intermediate layer. However, the present disclosure is not limited thereto.

In an illustrative embodiment, the protection film may be a thin film having thickness of about 100 nm or about nm or less. However, the present disclosure is not limited thereto.

In another illustrative embodiment, the protection film may be transparent, flexible, or transparent and flexible. However, the present disclosure is not limited thereto.

The insulating polymer may include an insulating polymer selected from the group consisting of a thermosetting resin, an photocurable resin, and a combination thereof. However, the present disclosure is not limited thereto.

In an illustrative embodiment, the preparing method may further include forming an adhesive layer containing an insulating or conductive polymer between the substrate and the graphene film. However, the present disclosure is not limited thereto.

In another illustrative embodiment, the preparing method may further include doping the graphene film prior to forming the protection film. However, the present disclosure is not limited thereto.

In another illustrative embodiment, doping the graphene film may include doping the graphene film by using organic-based and/or inorganic-based dopant. However, the present disclosure is not limited thereto.

In another illustrative embodiment, the graphene film may be formed on a metal catalyst thin film through a chemical vapor deposition method. However, the present disclosure is not limited thereto.

In another illustrative embodiment, the metal catalyst thin film may include one selected from the group consisting of Ni, Co, Fe, Pt, Au, Al, Cr, Cu, Mg, Mn, Mo, Rh, Si, Ta, Ti, W, U, V, Zr, Ge, Ru, Ir, brass), bronze, nickel, stainless steel, and a combination thereof. However, the present disclosure is not limited thereto.

In another illustrative embodiment, forming the protection film may be performed by processes including bar-coating, wire bar-coating, spin coating, dip coating, casting, micro gravure coating, gravure coating, roll coating, immersion coating, spray coating, screen printing, flexo printing, offset printing, or inkjet printing. However, the present disclosure is not limited thereto.

In another illustrative embodiment, forming the protection film containing the insulating inorganic material or the intermediate layer containing the conductive inorganic material may be performed by processes including a vacuum deposition method. However, the present disclosure is not limited thereto.

Hereinafter, the illustrative embodiments of the present disclosure will be described in detail with reference to the accompanying documents. However, the present disclosure is not limited thereto.

With reference to FIG. 1, a stable graphene film 100 in accordance with an illustrative embodiment of the present disclosure may include a substrate 110, an adhesive layer 120 formed on a top portion of the substrate 110, a graphene film 130, an intermediate layer 140, and a protection film 150. If necessary, a graphene layer may be further included between the protection film 150 and the intermediate layer 140.

Hereinafter, a method for preparing a stable graphene film including a protection film formed on the top and bottom portions of the graphene film will be described.

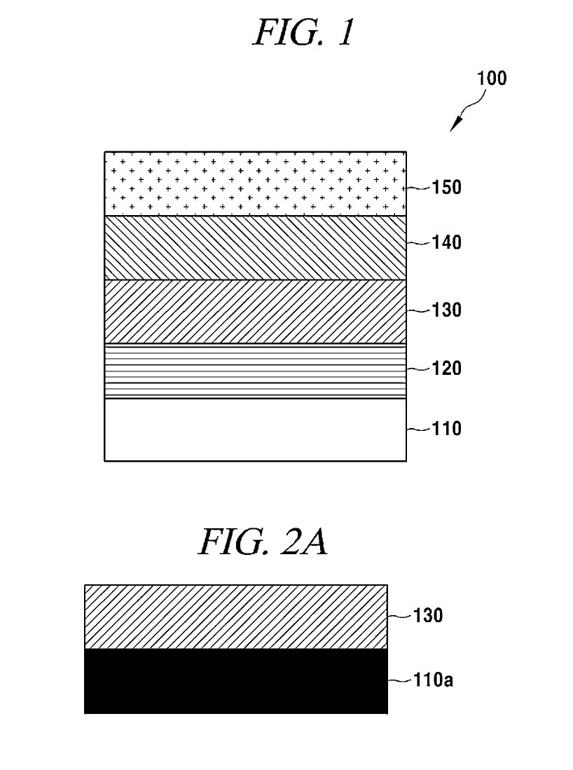

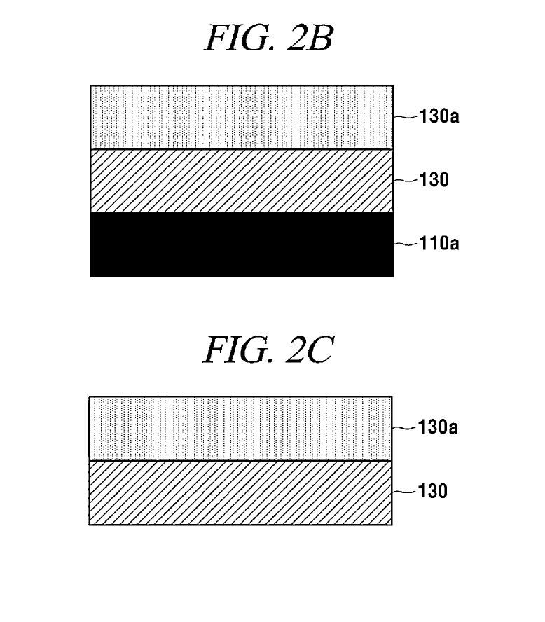

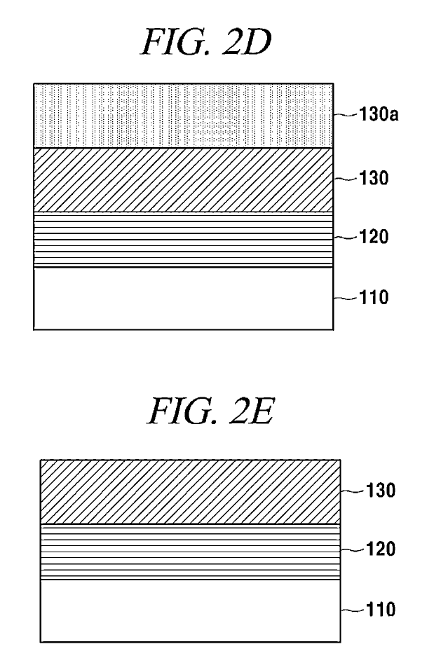

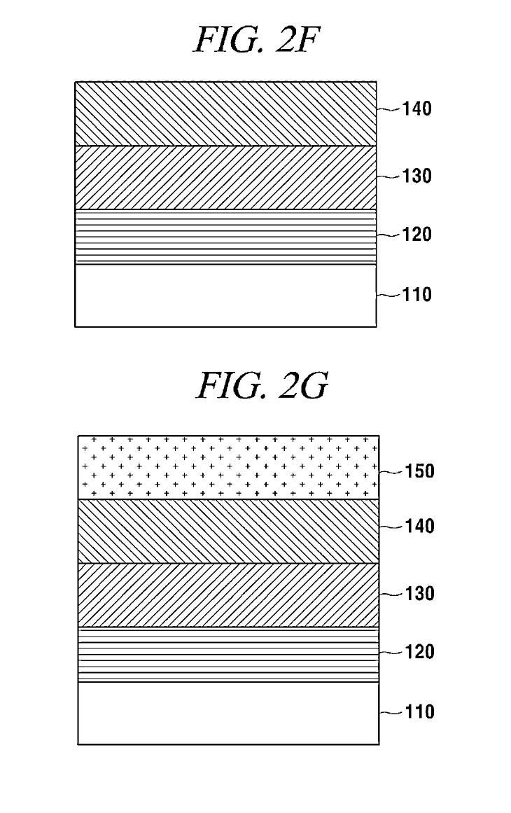

FIGS. 2A to 2G are cross sectional views for explanation of processes of a method for preparing a stable graphene film in accordance with an illustrative embodiment of the present disclosure.

With reference to FIG. 2A, the graphene film 130 may be formed by growing graphene on a metal catalyst thin film 110a through a chemical vapor deposition method. The metal catalyst thin film 110a is formed to facilitate the growth of the graphene. Materials for the metal catalyst thin film 110a may not be limited.

The metal catalyst thin film 110a may include at least one metal or alloy selected from the group consisting of Ni, Co, Fe, Pt, Au, Al, Cr, Cu, Mg, Mn, Mo, Rh, Si, Ta, Ti, W, U, V, Zr, Mo, Ir, Ge, brass, bronze, nickel, and stainless steel. Thickness of the metal catalyst thin film 110a is not limited, and may be a thin or thick film.

As the method for forming the graphene film 130, any method generally used in the art of the present disclosure to grow graphene may be used without limitation. For example, a chemical vapor deposition (CVD) method may be used. However, the present disclosure is not limited thereto. The chemical vapor deposition method may include rapid thermal chemical vapour deposition (RTCVD), inductively coupled plasma-chemical vapor deposition (ICP-CVD), low pressure chemical vapor deposition (LPCVD), atmospheric pressure chemical vapor deposition (APCVD), metal organic chemical vapor deposition (MOCVD), and plasma-enhanced chemical vapor deposition (PECVD). However, the present disclosure is not limited thereto.

For the graphene film 130, graphene can be grown by injecting a vapor carbon supply source to a substrate, on which the metal catalyst thin film 110a is formed, and heating the substrate. In an illustrative embodiment, after forming the metal catalyst film 110a on the substrate, the substrate is placed in a chamber. While vaporously injecting, into the chamber, a carbon supply source such as carbon monoxide, methane, ethane, ethylene, ethanol, acetylene, propane, butane, butadiene, pentane, pentene, cyclopentadiene, hexane, cyclohexane, benzene, or toluene into the chamber, the substrate is heated, for example, at a temperature of about 300° C. to about 2,000° C. As a result, graphene is generated while carbon components existing in the carbon supply source are bonded to one another to form a hexagonal plate shape structure. By cooling the graphene, the graphene film 130 in a uniformed arrangement state is obtained. However, the method for forming graphene on the metal catalyst thin film 110a is not limited to the chemical vapor deposition method. In an illustrative embodiment of the present disclosure, any method that forms graphene on the metal catalyst thin film 110a may be used. It is understood that the present disclosure is not limited to the certain method that forms graphene on the metal catalyst thin film.

A transparent electrode including the graphene film 130 may be applied to various fields such as a liquid crystal display device, an electronic paper display device, an organic light emitting display device, a tough screen, a flexible display apparatus, an organic LED, a solar cell, and the like. It is preferable to properly adjust thickness of the graphene film 130 used as the transparent electrode in the above-described various fields in consideration of transparency. For example, the thickness of the graphene film may be about 0.1 nm to about 200 nm, or about 0.1 nm to about 100 nm. If the thickness of the transparent electrode exceeds about 200 nm, the transparency is degraded so that light efficiency may be deteriorated. If the thickness of the transparent electrode is below about 0.1 nm, the sheet resistance is overly reduced, or the thin film may become ununiformed.

The graphene film 130 may be doped before the intermediate layer 140 and the protection film 150 are formed on the graphene film 130. By doping the graphene film with dopant, difference in work function between the dopant and the graphene film 130 can be reduced. Accordingly, the conductivity is improved, thereby complementing the electrical characteristic.

The dopant may be, but not limited to, organic-based and/or inorganic-based dopant. For example, the organic-based dopant may include one selected from the group consisting of NO₂BF₄, NOBF₄, NO₂SbF₆, HCl, H₂PO₄, H₃CCOOH, H₂SO₄, HNO₃, dichlorodicyanoanquinon, oxon, dimyristoylphosphatidylinositol, trifluoromethane sulfonimide, and a combination thereof. However, the present disclosure is not limited thereto.

For example, the inorganic-based dopant may include one selected from the group consisting of AuCl₃, HAuCl₄, AgOTfs (silver trifluoromethanesulfonate), AgNO₃, aluminum trifluoromethanesulfonate, and a combination thereof. However, the present disclosure is not limited thereto.

Subsequently, as illustrated in FIG. 2B, a protection layer 130a may be formed on the graphene film 130. In order to apply the graphene film 130 including the protection layer 130a to an applicable device, there may be the necessity to remove the metal catalyst thin film 110a for the growth of the graphene film 130. The metal catalyst thin film 110a for the growth of the graphene film 130 is removed by an etching method such as a wet or dry etching method. For example, in case of wet etching, the metal catalyst thin film 110a reacts with acid, which is an etchant, so as to be removed. However, during the process of removing the metal catalyst thin film 110a, the graphene film 130 formed on the metal catalyst thin film 110a may be damaged. Accordingly, the protection layer 130a may be formed to protect the graphene film 130 from the etching process.

Subsequently, the metal catalyst thin film 110a may be removed as illustrated in FIG. 2C. For example, removing the metal catalyst thin film 110a may be performed through dry etching using an etching apparatus such as reactive ion etching (RIE), inductively coupled plasma RIE (ICP-RIE), electron cyclotron resonance RIE (ECR-RIE), reactive ion beam etching (RIBE), or chemical assistant ion beam etching (CAIBE); wet etching using an etchant such as potassium hydroxide (KOH), tetra methyl ammonium hydroxide (TMAH), ethylene diamine pyrocatechol (EDP), burrered oxide etch (BOE), FeCl₃, Fe(NO₃)₃, HF, H₂SO₄, HNO₃, HPO₄, HCl, NaF, KF, NH₄F, AlF₃, NaHF₂, KHF₂, NH₄HF₂, HBF₄, and NH₄BF₄; or a chemical mechanical polishing process using an oxide film etching agent.

Subsequently, as illustrated in FIG. 2D, the graphene film 130 and the protection layer 130a may be transferred so as to be formed on the substrate 110. The substrate 110 is an insulating substrate, and may be transparent, flexible, or transparent and flexible. However, the present disclosure is not limited thereto. For example, the substrate 110 may be a substrate formed of the following material: polyethylene terephthalate (PET), polybuthylene terephthalate (PBT), polysilane, polysiloxane, polysilazane, polyethylene (PE), polycarbosilane, polyacrylate, polymethacrylate, polymethylacrylate, PMMA, polyethylacrylate, cyclic olefin copolymer (COC), polyethylmetacrylate, cyclic olefin polymer COP, polypropylene (PP), polyimide (PI), polystyrene (PS), polyvinylchloride (PVC), polyacetal (POM), polyetheretherketone (PEEK), polyestersulfon (PES), polytetrafluoroethylene (PTFE), or polyvinylidenefloride (PVDF), perfluoroalkyl polymer (PFA). However, the present disclosure is not limited thereto.

The adhesive layer 120 containing an insulating polymer may be formed on the substrate 110. For example, the adhesive layer 120 may be conductive or insulating, and include one selected from the group consisting of a photo resist, a water soluble poly urethane resin, a water soluble epoxy resin, a water soluble acryl resin, a water soluble natural polymer resin, a water-based adhesive, a vinyl acetate emulsion adhesive, a hot-melt adhesive, a visible light curing adhesive, an infrared ray curing adhesive, an electron beam curing adhesive, polybenizimidazole (PBI), a polyimide adhesive, a silicon adhesive, an imide adhesive, a bismaleimide (BMI) adhesive, a modified epoxy, and a combination thereof. However, the present disclosure is not limited thereto.

The adhesive layer 120 may improve an adhesive force when the graphene film 130 is transferred onto the substrate 110.

Subsequently, as illustrated in FIG. 2E, the protection layer 130a that has been formed on the graphene film 130 may be removed. After the process of transferring the graphene film 130 onto the substrate, the protection layer 130a formed on the graphene film 130 for protecting the graphene film 130 during the process of etching the metal catalyst thin film 110a may be removed by acetone or others.

Subsequently, as illustrated in FIG. 2F, the intermediate layer 140 may be formed on the graphene film 130. The intermediate layer 140 may contain a conductive polymer or a conductive inorganic material. For example, the conductive polymer may include one selected from the group consisting of polyaniline, polythiophene, polyethylenedioxythiopene (PEDOT), polyimide, polystyrenesulfonate (PSS), polypyrrole, polyacetylene, poly(p-phenylene), poly(p-phenylene sulfide), poly(p-phenylene vinylene), polythiophene poly(thienylene vinylene), and a combination thereof. However, the present disclosure is not limited thereto. For example, the conductive inorganic material may include one selected from the group consisting of indium tin oxide (ITO), indium zinc oxide (IZO), antimony-doped tin oxide (ATO), Al-doped zinc oxide (AZO), gallium-doped zinc oxide (GZO), indium-gallium-zinc oxide (IGZO), fluorine-doped tin oxide (FTC)), ZnO, TiO₂, SnO₂, WO₃, and a combination thereof. However, the present disclosure is not limited thereto.

Subsequently, as illustrated in FIG. 2G, the protection film 150 may be formed on the intermediate layer 140.

If necessary, forming the graphene film on the intermediate layer 140 may be further included prior to forming the protection film 150. The method for further forming the graphene film is the same as the method for forming the graphene film 130. Overlapping descriptions of the method for further forming the graphene film will be omitted.

The protection film 150 formed on the intermediate layer 140 may be transparent and flexible, and contain an insulating polymer or an insulating inorganic material. The insulating polymer may include a curable insulating polymer. For example, the curable insulating polymer may include one selected from the group consisting of a thermosetting resin, a photocurable resin, and a combination thereof. However, the present disclosure is not limited thereto.

For example, the insulating polymer may include one selected from the group consisting of poly methyl methacrylate (PMMA), poly 4-vinylphenol (P4VP), polystyrene-block-polyisoprene-block-polystryrene (SBS), polyvinylchloride (PVC), polypropylene (PP), acrylonitrile butadiene styrene (ABS), polycarbonate (PC)/acrylonitrile butadiene styrene (ABS), polyurethane (PU), polyvinylchloride (PVC), polystyrene (PS), phenolic (PF) polyethylene (PE), polyethylene terephthalate (PET), polybuthylene terephthalate (PBT), polyphenylene sulfide (PPS), poly carbonate (PC), nylon, low density polyethylene (LDPE), high density polyethylene (HDPE), cross-linked polyethylene (XLPE), styrenebutadiene rubber (SBR), butadiene rubber (BR), ethylene propylene rubber (EPR), polyurethane (PU), tetraorthosilicate (TEOS), and a combination thereof. However, the present disclosure is not limited thereto.

For example, the insulating inorganic material may include one selected from the group consisting of SiO₂, a-Si(amorphous silicon), SiC, Si₃N₄, LiF, BaF₂, Ta₂O₅, Al₂O₃, MgO, ZrO₂, HfO₂, BaTiO₃, BaZrO₃, Y₂O₃ZrSiO₄, and a combination thereof. However, the present disclosure is not limited thereto.

The protection film 150 may be a thin film having thickness of about 200 nm or less, about 100 nm or less, about 50 nm or less, about 30 nm or less, about 20 nm or less, or about 10 nm or less. However, the present disclosure is not limited thereto. A lower limit for the thickness of the protection film may be about 0 nm or more, about 0.1 nm or more, about 1 nm or more, about 2 nm or more, about 3 nm or more, about 4 nm or more, or about 5 nm or more. However, the present disclosure is not limited thereto. If the thickness of the protection film exceeds 100 nm, the conductivity of the graphene film 130 is reduced. If the thickness of the protection film is below 0.1 nm, the protection film may not implement the function of protecting the graphene film 130 from damage and the function of preventing degradation of the conductivity. However, the present disclosure is not limited thereto.

In case of using sol or a solution-based material, the protection film may be formed by a method selected from the group consisting of bar-coating, wire bar-coating, spin coating, dip coating, casting, micro gravure coating, gravure coating, roll coating, immersion coating, spray coating, screen printing, flexo printing, offset printing, inkjet printing, and a combination thereof. However, the present disclosure is not limited thereto. The protection film containing the insulating inorganic material or the intermediate layer containing the conductive inorganic material may be formed by a vacuum deposition process. For example, the vacuum deposition method may be selected from the group consisting of sputter, plasma-enhanced chemical vapor deposition (PECVD), thermal chemical vapour deposition (thermal CVD), and a combination thereof. However, the present disclosure is not limited thereto.

As described above, by forming the adhesive layer 120 on the top portion of the substrate, the adhesive force of the graphene film 130 on the substrate can be improved. By forming the intermediate layer 140 and the protection film 150 on the top portion of the graphene film 130, the graphene film can be protected from external factors such as air, moisture, and scratches. Accordingly, it is possible to prevent variation of the electrical characteristic of the graphene. Further, in case of using a graphene electrode using the stable graphene film 100 prepared in accordance with the present disclosure as a display such as a touch screen, the display can be protected from external scratches. As usage time lapses, the conductivity of the graphene is reduced, so that the touch sensitivity is reduced. In this case, the protection film 150 prevents dopant doped on the graphene from being blown or degraded, so that the conductivity can be maintained for a long time.

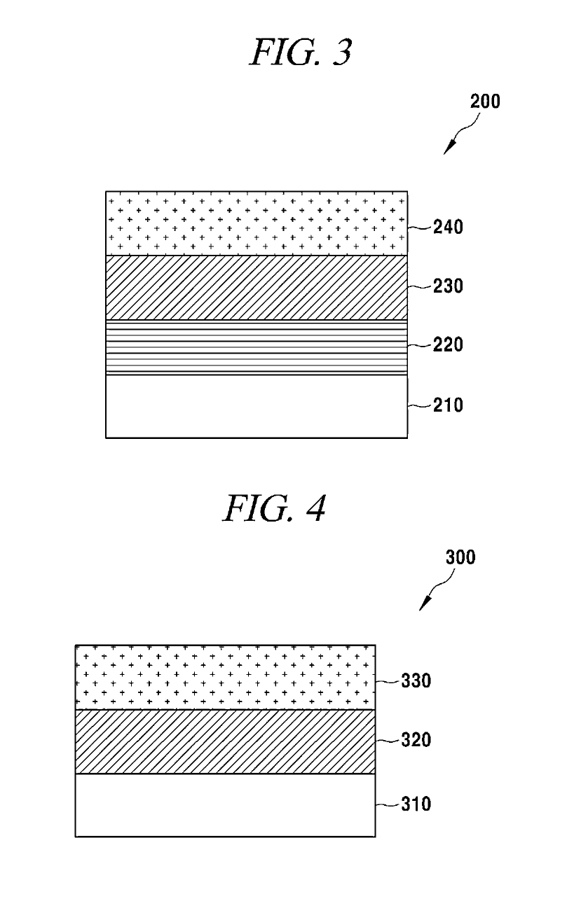

FIG. 3 is a cross sectional view showing a stable graphene film in accordance with another illustrative embodiment of the present disclosure. With reference to FIG. 3, a stable graphene film 200 in accordance with another illustrative embodiment of the present disclosure may include a substrate 210, an adhesive layer 220, a graphene film 230, and a protection film 240.

In the stable graphene film 200, the protection film 240 may be formed directly on the graphene film 230 without forming an intermediate layer. Accordingly, the preparing process may be simplified.

FIG. 4 is a cross sectional view showing a stable graphene film in accordance with another illustrative embodiment of the present disclosure. With reference to FIG. 4, a stable graphene film 300 in accordance with another illustrative embodiment of the present disclosure may include a substrate 310, a graphene film 320, and a protection film 330.

In the stable graphene film 300, the graphene film 320 may be adhered onto the substrate 310 only through the adhesive force of the substrate 310 and the graphene film 320 without requiring an adhesive layer. Further, the protection film 330 may be formed directly on the graphene film 320 without requiring a separate intermediate layer. Accordingly, the preparing process can be simplified.

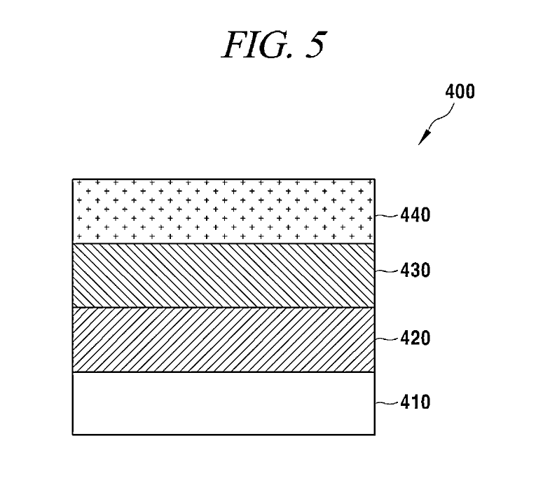

FIG. 5 is a cross section view showing a stable graphene film in accordance with another illustrative embodiment of the present disclosure. With reference to FIG. 5, a stable graphene film 400 in accordance with another illustrative embodiment of the present disclosure may include a substrate 410, a graphene film 420, an intermediate layer 430, and a protection film 440.

In the stable graphene film 400, the graphene film 420 may be adhered onto the substrate 410 only through the adhesive force of the substrate 410 and the graphene film 420 without requiring an adhesive layer. Accordingly, the preparing process can be simplified.

Accordingly, the stable graphene prepared in accordance with the present disclosure has a large surface area, compared to graphene obtained by other physical methods, and may be adopted for various applications such as a transparent electrode, a conductive thin film, a hydrogen storage medium, an optical fiber, an electronic device, a display, and the like.

Graphene has inspired academic and industrial enthusiasm by virtue of its excellent mechanical (˜25% break deformation and ˜1 TPa elasticity modulus), optical (˜97.7% transmittance of monolayer graphene), and electrical (maximum 200,000 cm²/Vs mobility at a room temperature) characteristics. The unique 2D honeycomb structure of the graphene facilitates absorbing organic molecules and holding strong bonds. This implies that the excellent characteristics might have been affected in their normal states. Accordingly, applying the protection layer to the graphene film is very important, and at the same time, can maintain the excellent characteristics of the graphene. For example, a poly(3,4-ethyldioxythiophene)-doped poly(styrenesulfonate) (PEDOT:PSS) polymer is an outstanding candidate for the above-described purpose by virtue of its combined characteristics, transparency, and environmental stability. If the PEDOT:PSS polymer is combined with the graphene film, the graphene surface characteristic including the hydrophobic characteristic and the hydrophilic characteristic induced by the PEDOT:PSS can provide a broad range of potential applications.

Hereinafter, the present disclosure will be specifically described with reference to examples and drawings. However, the present disclosure is not limited to the examples and the drawings.

### Example 1

### Synthesis and Transfer of Monolayer Graphene

Monolayer graphene was synthesized on a Cu catalyst by a chemical vapor deposition (CVD) method, which was a process known prior to the present dwasclosure. A Cu foil having thickness of 25 μm was inserted into a quartz tube. Thereafter, the tube was heated to 1000° C. at an ambient pressure under flow of H₂ and Ar. After a reaction gas mixture (CH₄:H₂:Ar) with 50:15:1000 sccm was supplied for about 5 minutes, the sample was rapidly cooled to a room temperature. After the synthesis of the graphene, a polymer supporting layer of poly(methylmethacrylate) (PMMA) was spin-coated on the graphene surface, in order to protect the graphene during a wet chemical etching process. Thereafter, the Cu foil was etched by ammonium persulphate ((NH₄)₂S₂O₈) solution, and subsequently, cleaned with deionized water. In this step, the PMMA-supported graphene was prepared to be transferred onto a desired substrate, e.g., a Si wafer or flexible PET. After the transfer, the PMMA supporting layer was removed by acetone.

In Example 1, polymers used as an insulating polymer protection film were PMMA, poly(4-vinylphenol)(P4VP), and polystyrene-block-polyisoprene-block-polystyrene (SBS). As solvents for dissolving PMMA, P4VP, and SBS, chlorobenzene, prophylene glycol monomethyl ether acetate (PGMEA), and 2-butanone, respectively, were used. All the polymer materials and the solvents were purchased from Aldrich Sigma, and used as they were. Various types of solutions having different concentrations of 0.1 mg/ml to 20 mg/ml were prepared to prepare an insulating polymer protection film having desired thickness.

Thickness of a bar-coating layer can be properly adjusted by the solution concentration and bar-coating velocity. Thickness of the insulating polymer protection film was measured by ellipsometer.

Transmission spectrum was acquired by using a blank PET substrate as a reference through UV-vis-NIR measurement. Sheet resistance of the film was measured by a 4-point probe apparatus. The sheet resistance was calculated by the equation below.

$$Rs = \frac{π}{ln 2} \frac{V}{I} = 4.5324 \frac{V}{I} .$$

Doping with AuCl₃ was accomplished by dripping an AuCl₃/nitromethane solution on the surface of the graphene for a desired time, and then, drying the surface through a nitrogen stream. A scratch tape was used in a taping test.

Analysis of Characteristics

Form and an optical characteristic of a monolayer graphene film, on which the insulating polymer protection film was formed by bar-coating

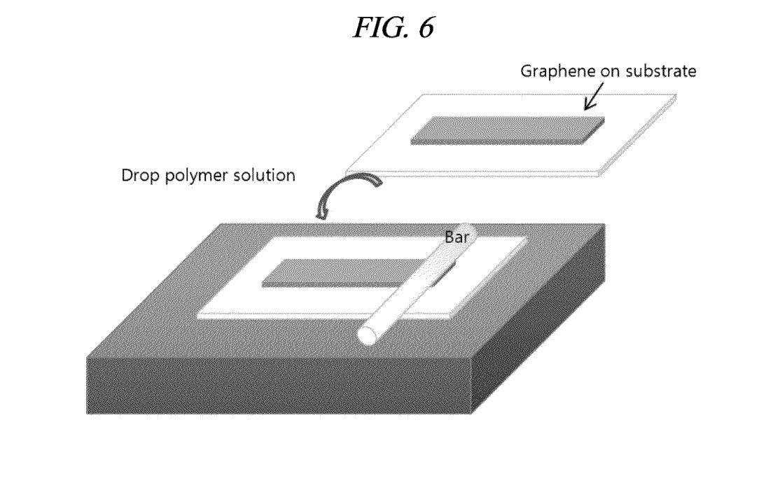

The above-described whole processes are illustrated in a schematic view of FIG. 6.

First, the monolayer graphene grew on the Cu foil. The graphene film was separated by protecting the graphene film with PMMA. A Cu catalyst placed on the bottom portion of the graphene film was etched by using ammonium sulfate. Subsequently, the film was transferred onto a desired substrate, e.g., a Si wafer or a PET substrate. The PMMA layer was dissolved and removed by acetone, and then, the insulating polymer protection film was bar-coated on the graphene surface.

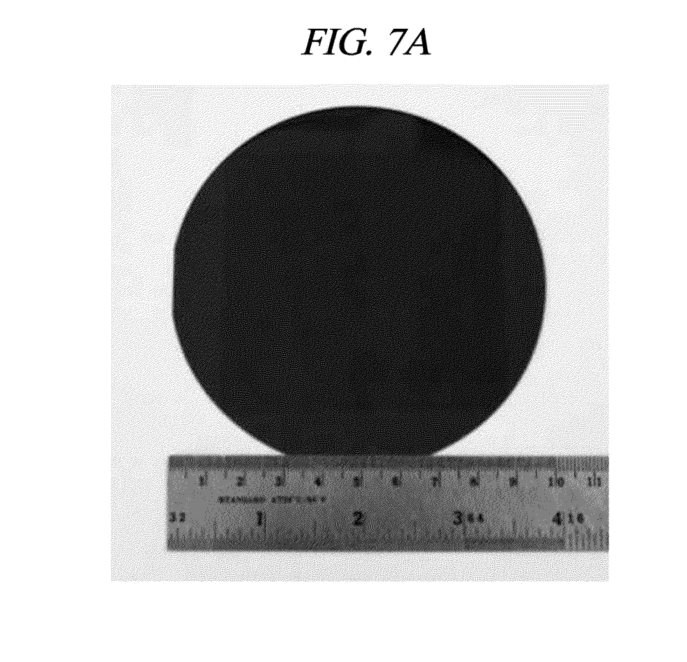

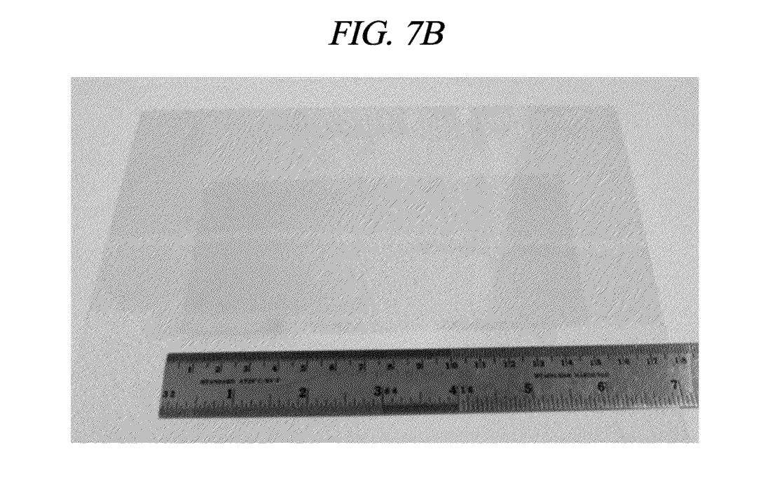

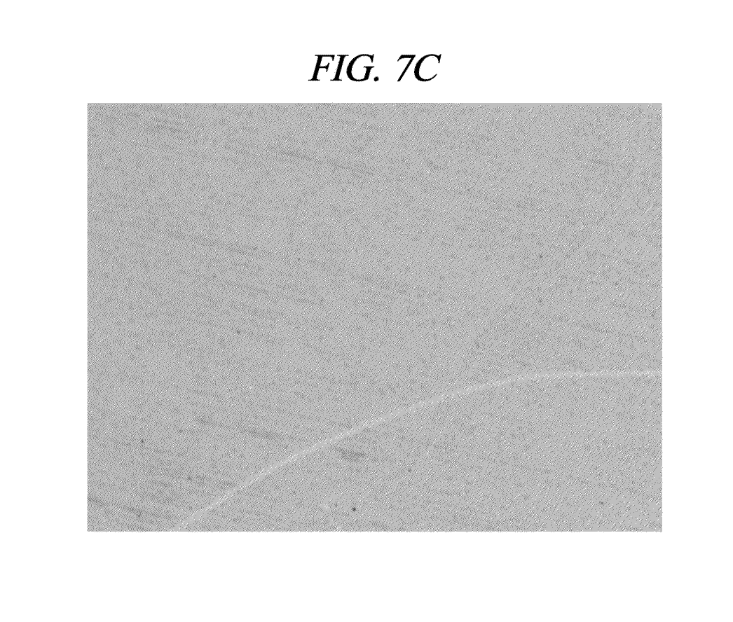

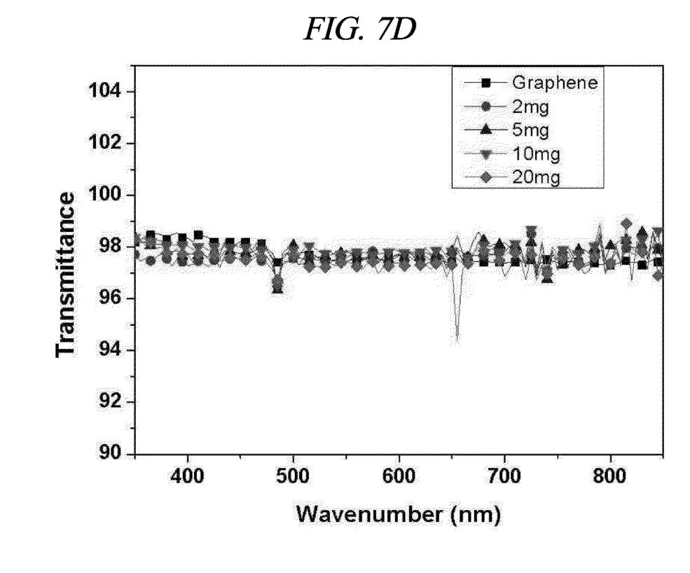

FIGS. 7A and 7B are photographs of the graphene film after the bar-coating of the insulating polymer protection film on a 3-inch Si wafer and a PET substrate, respectively, by using P4VP. As shown in the photographs, the monolayer graphene film in a wafer scale was transferred onto the Si, and the monolayer graphene film having a large surface are of 15×8 cm² was transferred onto the PET. The uniformed insulating polymer protection film was accomplished by cautiously controlling conditions for the solvents and the bar-coating on the Si wafer and the PET substrate.

An optical microscope was used to further identify the uniformity of the insulating polymer protection film bar-coated on the graphene surface (FIG. 7C). A 300 nm SiO₂/Si wafer was adopted as the substrate since the monolayer graphene film on the wafer can be discriminated by color contrast through the optical microscope. The dots in FIG. 7C are bilayer graphene or trilayer graphene, and cannot be avoided since the Cu catalyst was used to grow the monolayer graphene. The artificial scratches apparently show that the insulating polymer protection film was covered on the graphene surface. The bar-coating provides a direct and effective method to prepare the top portion insulating polymer protection film in a large scale.

The high transmittance was one of the essential advantages of the CVD graphene film. The high transmittance enables the CVD graphene film to be a strong candidate for photoelectronic application such as a transparent electrode. The reported absorbance of the monolayer graphene was about 2.3%. The monolayer graphene film used in Example 1 has 97.5% transmittance and ˜450 Ω/sq sheet resistance (Rs) on the PET substrate. The insulating polymer protection film does not affect the optical characteristics. FIG. 7D shows the transmittance of the graphene on the PET substrate prior to and after the bar-coating of the insulating polymer protection film. The PET was used as a background. All the samples exhibit very slight variation of transmittance in a wave number range of about 350 nm to about 850 nm within an error range.

Sheet Resistance of a Monolayer Graphene Film by the Top Portion Coating of the Insulating Polymer Protection Film

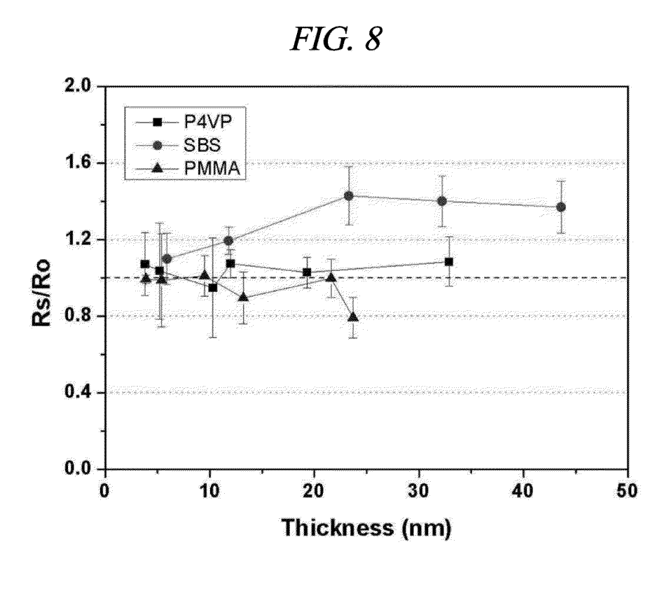

Insulating polymer protection films having different thicknesses were bar-coated on the top portion of the monolayer graphene film by tuning conditions. Various types of polymers were applied to the bar-coating process for formation of the insulating polymer protection films. Finally, three types of polymers, i.e., P4VP, PMMA, and SBS, were used to form insulating polymer protection films in the form of a uniformed thin film on the graphene film. FIG. 8 shows variation of the sheet resistance of the graphene film depending on thickness of the top portion insulating polymer protection films. The sheet resistance of the graphene film bar-coated with SBS was 20 nm at first and gradually increased to ˜40%. As the thickness of the top portion layer increases, the sheet resistance was saturated. Unexpectedly, the sheet resistance of the graphene film coated with PMMA was reduced by about 20% as the thickness increases. In case of the P4VP, the sheet resistance of the graphene film did not vary as the thickness increases, and only has fluctuation of less than 10%. As the thickness of the top portion insulating polymer protection film further increases, the graphene film was thoroughly capsulated and insulated.

Intuitively, the top portion insulating polymer protection film formed with the insulating layer polymer was expected to increase the sheet resistance of the graphene film by virtue of increased probe contact resistance. After the coating with the thin insulating polymer protection film, the different tendencies of the sheet resistance of the graphene films are understood to have resulted from different interactions between the coated insulating polymer and the graphene film. It has been suggested that a medium having good contact with the graphene have a surface tension value of 40-50 mJ/m². Good match of the hydrophobic interaction between the graphene and the SBS and the surface tension (about 45 mJ/m²) is deemed to contribute to the gradually increasing sheet resistance of the graphene film. The PMMA can spread on the graphene film, and may be widely used as a supporting layer during the process of transferring the graphene. The PMMA coating layer can minimize cracks of the graphene film induced in the transferring process, which is understood to be related to the small reduction of the sheet resistance after the coating. The P4VP has normal interaction with the graphene, and the resulting insulating polymer protection film slightly affects the sheet resistance of the graphene.

Taping Test

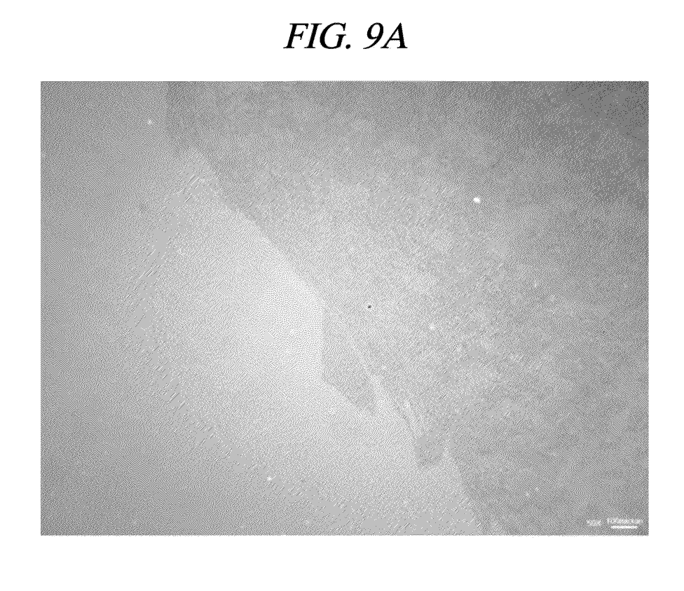

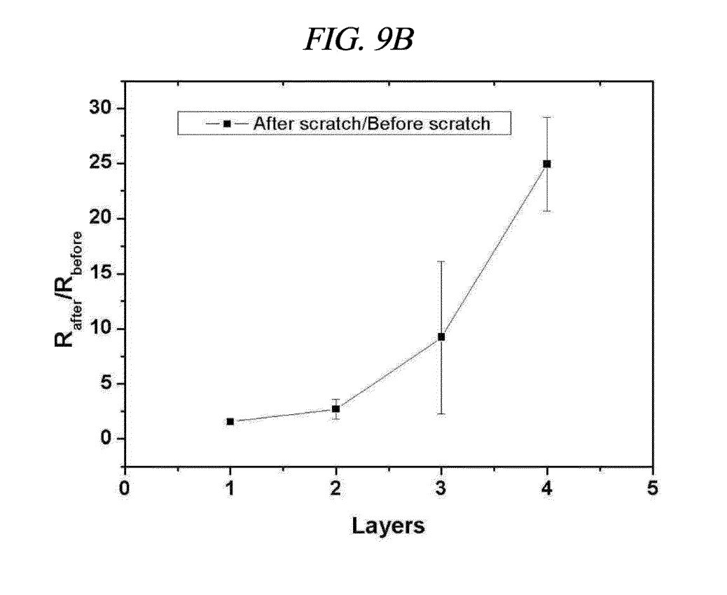

A taping test was performed to study mechanical stability of the graphene film having the bar-coated insulating polymer protection film. FIG. 9A is an optical microphotograph of the graphene film coated with the insulating polymer protection film on the silicon substrate after a taping test. As shown in the right upper part of the image in FIG. 9A, the insulating polymer protection film and the graphene film were destroyed by the taping test. After the taping, the film becomes discontinuous, and no conductivity was measured. This shows weak bond between the graphene and the silicon wafer. In case of the PET substrate, the effective hydrophobic interaction between the graphene and the PET substrate enables the graphene to be more stable during the taping test. On the PET substrate, the graphene film having the insulating polymer protection film maintained about 50% increase of the conductivity and the sheet resistance after the taping test. The multilayer graphene film was transferred layer by layer onto the PET substrate. Subsequently, when the film was bar-coated with the insulating polymer protection film, the taping process has a stronger effect in the sheet resistance of the thicker graphene film. FIG. 9B shows variation of the sheet resistance prior to and after the taping test for monolayer, bilayer, trilayer, and tetralayer graphene films coated with the insulating polymer protection film. The increase of the sheet resistance of the multilayer graphene film after the taping test appears to have resulted from the weak interaction between adjacent graphene layers. This results in damages to the upper layer graphene during the taping test.

Effect of Coating the Insulating Polymer Protection Film for the AuCl₃-Doped Graphene Film

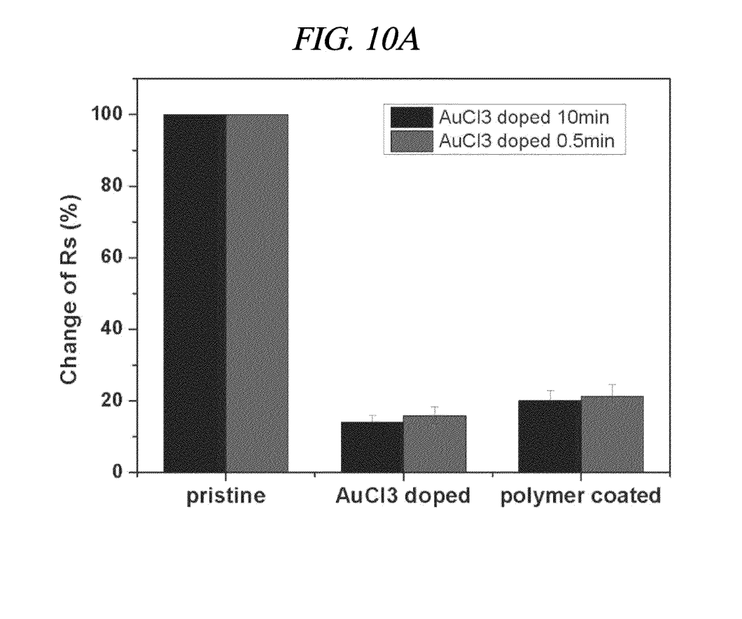

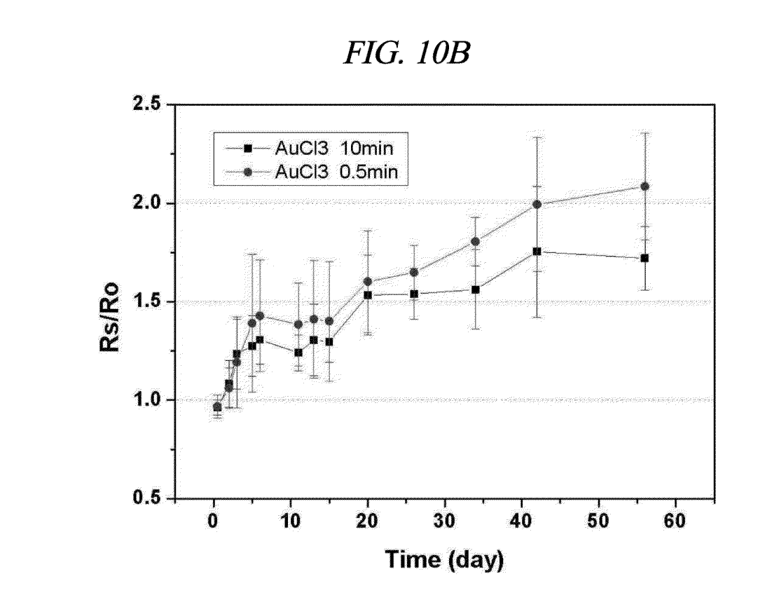

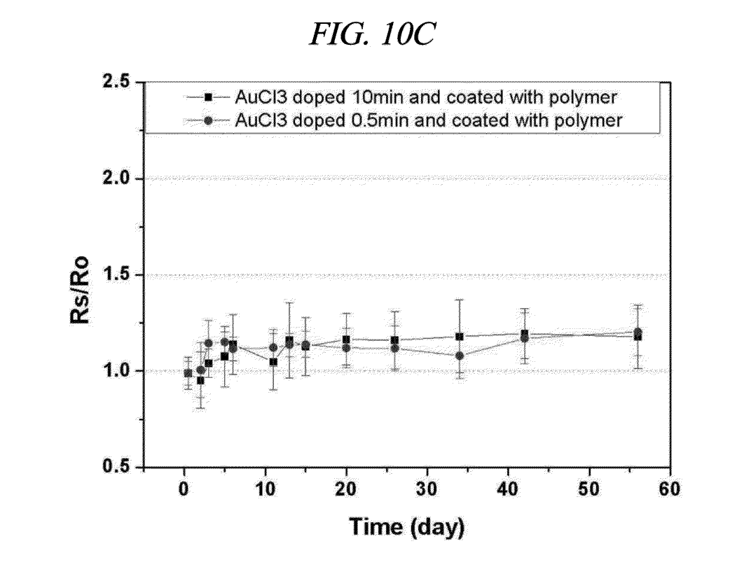

Graphene has been suggested as a candidate material for high-performance transparent conductive films (TCFs). However, the sheet resistance of the graphene was still higher than that of carbon nanotube-based TCFs and ITO. AuCl₃ in nitromethane having a 0.025 M concentration was used to dope the graphene film. As illustrated in FIG. 10A, the sheet resistance of the doped graphene film decreased from 792 Ω/sq, which is average sheet resistance of a pure graphene film, to 111 Ω/sq after doping with AuCl₃ for 10 minutes, which corresponds to a ˜86% decrease. The drastic drop of the sheet resistance was construed as extraction of electrons from the graphene due to reduction from Au³⁺ into Au⁰. Accordingly, a hole carrier concentration increased. In addition to the transmittance higher than 95%, the low sheet resistance makes the doped monolayer graphene very competitive, compared to an ITO electrode having about 85% transmittance and typical 5-60 Ω/sq sheet resistance.

The doping stability has been studied for a long time. FIG. 10B shows sheet resistance of an AuCl₃-doped sample, which varies with lapse of time. For first few days, the sheet resistance rapidly increased to about 40% for 10 minutes with respect to the AuCl₃ doped graphene film. Thereafter, the sheet resistance gradually decreased as time lapses. After 56 days, the sheet resistance increased up to 116% and 72% with respect to the graphene films doped for 10 minutes and 0.5 minutes, respectively. The graphene films depending on the different doping times exhibit the same tendency as time lapses as shown in FIG. 10B. A hygroscopic nature of a Cl⁻ ion of the AuCl₃ dopant may be a cause for improvement of the sheet resistance of the doped sample stored in the atmosphere. After the top portion of the doped sample was coated with the insulating polymer protection film, the sheet resistance exhibited ˜30% to 40% increase. However, the doped graphene film that has the coated polymer film exhibited excellent stability in environment conditions; the sheet resistance exhibited fluctuation of below 20% even after about 2 months, irrespective of the doping time (FIG. 10C). The stability appears to have been accomplished because the hydrophobic polymer film impedes the hygroscopic process of the Cl⁻ ion.

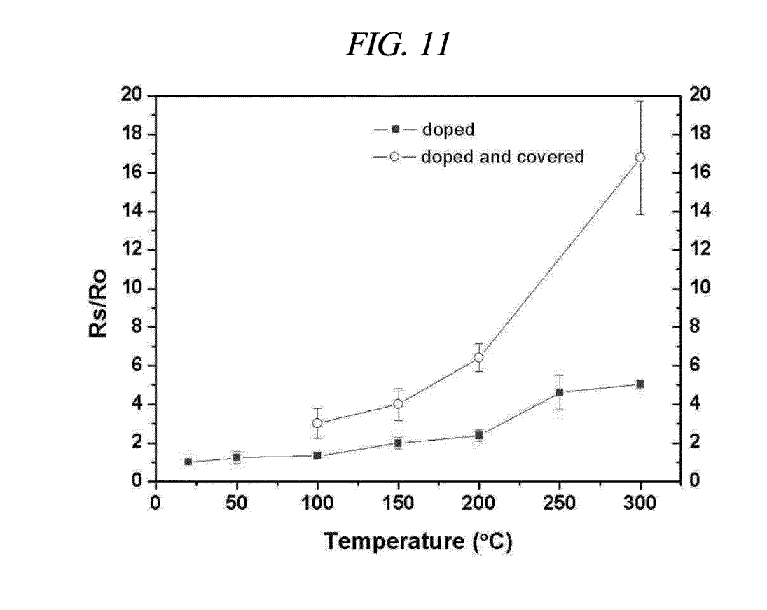

The stability of the graphene film depending on temperature was also monitored. The sample was annealed at different temperatures under flow of Ar. The sheet resistance of the AuCl₃-doped sample having the insulating polymer protection film was measured with functions of the annealing temperatures. FIG. 11 shows tendency of the sheet resistance varying depending on temperatures. Compared to the AuCl₃ doped graphene film, the doped graphene film had good stability when the temperature was below 150° C. The sheet resistance of the doped graphene film gradually increased until the temperature reaches 200° C., and rapidly increased at 250° C. or more. Meanwhile, the doped graphene film coated with the insulating polymer protection film was very unstable after the film was annealed at a temperature exceeding 100° C. Due to the low glass transition temperature of the polymer, as shown from the observation by the optical microscope, the insulating polymer protection film formed on the graphene film broke the uniformity after the annealing, and was condensed.

### Example 2

### Preparation of the Graphene Film

A monolayer graphene was synthesized on the Cu catalyst through the chemical vapor deposition (CVD) method. After growth of the graphene on the Cu foil, the PMMA polymer was spin-coated on the top portion. Thereafter, the Cu foil was etched by a 0.1M (NH₄)₂S₂O₈ solution. The PMMA/graphene film obtained as described above floated on deionized water so as to remove residues of the etching solution. In this step, the PMMA/graphene thin film was transferred onto the substrate. The PMMA was removed by acetone.

Coating Process

With the hydrophobic characteristic of the graphene film, water-soluble PEDOT/PSS cannot diffuse on the graphene surface, so that a uniformed film cannot be obtained after the bar-coating (or spin coating) process. Accordingly, a simple and effective method to solve the problem has been developed by adding a certain amount of isopropanol (IPA). It was discovered that when a proportion of IPA to PEDOT:PSS was 2 or more, PEDOT:PSS can be uniformly coated on the graphene film through bar-coating (or spin coating). Thickness of the PEDOT:PSS layer can be adjusted by a solvent proportion and bar-coating velocity. An AFM image shows that roughness of the PEDOT:PSS/graphene film was 2 nm or less.

Improvement of Characteristics

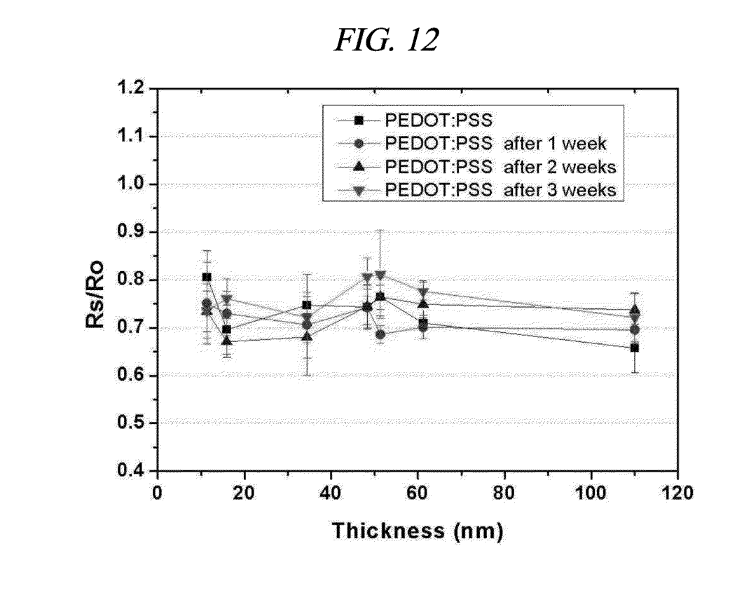

After the PEDOT:PSS thin film (10-110 nm) was coated on the surface of the graphene film, the graphene film exhibited little loss of transmittance. FIG. 12 shows improvement of the sheet resistance of the graphene film depending on thickness of the top portion coating PEDOT:PSS. The sheet resistance of the graphene film coated with PEDOT:PSS decreased from 450-570 Ω/sq of the pristine monolayer graphene to 330-410 Ω/sq of the PEDOT:PSS coated graphene film, which corresponds to about 20% to 40% decrease. The sheet resistance was not affected by the thickness of PEDOT:PSS. It was observed that the improvement of the electronic characteristic was very stable even after 3 weeks in the atmosphere.

The present disclosure has been described in detail with reference to illustrative embodiments and examples. However, it is clear that the present disclosure is not limited to the illustrative embodiments and the examples, and may be modified in various forms by those skilled in the art within the technical idea of the present disclosure.

### EXPLANATION OF CODES

100, 200, 300, 400: stable graphene film
110, 210, 310, 410: substrate
110a: metal catalyst thin film
120, 220: adhesive layer
130, 230, 320, 420: graphene film
140, 430: intermediate layer
150, 240, 330, 440: protection film

1. A stable graphene film, comprising a graphene film, and an insulating or conductive protection film formed on the graphene film.

2. The stable graphene film of claim 1,
wherein the protection film contains an insulating or conductive polymer, or an insulating or conductive inorganic material.

3. The stable graphene film of claim 1, further comprising an intermediate layer containing a conductive polymer or a conductive inorganic material between the protection film and the graphene film.

4. The stable graphene film of claim 3, further comprising a graphene layer between the protection film and the intermediate layer.

5. The stable graphene film of claim 1,
wherein the protection film has thickness of about 100 nm or less.

6. The stable graphene film of claim 2,
wherein the insulating polymer comprises a curable insulating polymer.

7-12. (canceled)

13. The stable graphene film of claim 1,
wherein the graphene film is doped.

14-19. (canceled)

20. The stable graphene film of claim 1, further comprising an adhesive layer containing an insulating or a conductive polymer between the substrate and the graphene film.

21-24. (canceled)

25. A graphene transparent electrode comprising the stable graphene film of claim 1.

26. A tough screen comprising the graphene transparent electrode of claim 25.

27. A method for preparing a stable graphene film, comprising forming an insulating or a conductive protection film on the graphene film.

28. The method for preparing a stable graphene film of claim 27, comprising:
forming the graphene film on a substrate; and
forming the protection film containing an insulating or conductive polymer, or an insulating or conductive inorganic material on a top portion of the graphene film.

29. The method for preparing a stable graphene film of claim 28, further comprising forming an intermediate layer containing a conductive polymer or a conductive inorganic material between the protection film and the graphene film.

30. The method for preparing a stable graphene film of claim 29, further comprising forming a graphene film between the protection film and the intermediate layer.

31. The method for preparing a stable graphene film of claim 27,
wherein the protection film is a thin film having thickness of about 100 nm or less.

32-33. (canceled)

34. The method for preparing a stable graphene film of claim 28, further including forming an adhesive layer containing an insulating or conductive polymer between the substrate and the graphene film.

35. The method for preparing a stable graphene film of claim 27, further including doping the graphene film prior to forming the protection film.

36-38. (canceled)

39. The method for preparing a stable graphene film of claim 27,
wherein forming the protection film is performed by processes comprising bar-coating, wire bar-coating, spin coating, dip coating, casting, micro gravure coating, gravure coating, roll coating, immersion coating, spray coating, screen printing, flexo printing, offset printing, or inkjet printing.

40. The method for preparing a stable graphene film of claim 27,
wherein forming the protection film containing the insulating or conductive inorganic material or the intermediate layer containing the insulating or conductive inorganic material is performed by processes comprising a vacuum deposition method.
